(19) United States
(12) Patent Application Publication
(10) Pub. No.: US 2014/0304040 A1
(43) Pub. Date: Oct. 9, 2014

(54) METHOD AND SYSTEM FOR IMPLEMENTING A COMPOSITE QUALITY PERFORMANCE INDEX

(71) Applicant: ORACLE INTERNATIONAL CORPORATION, Redwood Shores, CA (US)

(72) Inventors: Gregory SHOOK, Monument, CO (US); Manish SOMANI, Castle Rock, CO (US)

(73) Assignee: ORACLE INTERNATIONAL CORPORATION, Redwood Shores, CA (US)

(21) Appl. No.: 14/247,827

(22) Filed: Apr. 8, 2014

Related U.S. Application Data
(60) Provisional application No. 61/809,622, filed on Apr. 8, 2013.

(51) Int. Cl. G06Q 10/06

(52) U.S. Cl. CPC G06Q 10/06393
USPC 705/7.39

(57) ABSTRACT

Disclosed is an improved method and mechanism to implement a framework for defining multiple Quality Variables. Each quality variable corresponds to its own weight, measurement definitions, control range values and normalization formula.

### CROSS-REFERENCE TO RELATED APPLICATIONS

The present application claims the benefit of priority to U.S. Provisional Application No. 61/809,622, entitled “METHOD AND SYSTEM FOR IMPLEMENTING A COMPOSITE QUALITY PERFORMANCE INDEX” (Attorney Docket No. ORA130850-US-PSP) filed on Apr. 8, 2013, which is hereby incorporated by reference in its entirety.

### COPYRIGHT NOTICE

A portion of the disclosure of this patent document contains material which is subject to copyright protection. The copyright owner has no objection to the facsimile reproduction by anyone of the patent document or the patent disclosure, as it appears in the Patent and Trademark Office patent file or records, but otherwise reserves all copyright rights whatsoever.

### BACKGROUND AND SUMMARY

The present invention relates generally to methods and systems for evaluating and viewing data for project management.

Product and project development today poses unprecedented challenges. To stand out and succeed in competitive and crowded marketplaces, products must be continuously innovative and fresh. As short-lived market opportunities present themselves, product development efforts that once required years now must be executed in a matter of months.

In most of the established project management methodologies being used today, there are three areas that are deemed most important to be measured and managed in order to evaluate the health/status of a project:
1. Schedule
2. Cost
3. Quality

For the first 2 items (Schedule and Cost), there are well defined measurement models that have been implemented by most of the project management tools available in the market today.

For schedules, a Schedule Performance Index (SPI) can be established as a measure of progress achieved compared to planned progress, e.g., where:

Schedule Performance Index=(Earned Value)/(Planned Value)

The Schedule Performance Index reports on how efficiently the project is progressing compared to planned progress.
If SPI is greater than one, it means more work has been completed than planned work.
If SPI is less than one, it means less work has been completed than planned work.
If SPI is equal to one, it means work completed is equal to planned work.

For costs, a Cost Performance Index can be established that provides a measure of the value of work completed compared to the actual cost spent on the project, e.g., where:

Cost Performance Index=(Earned Value)/(Actual Cost)

The Cost Performance Index reports on how much earning has occurred for each dollar spent on the project.
If CPI is less than one, it means that the earning so far has been less than the spending.
If CPI is greater than one, it means that the earning so far is more than the spending.
If CPI is equal to one, it means that earning and spending is equal.

However, conventional project management systems do not have an effective or standard way to implement a measurement model for the quality of a project. This is because conventional systems do not have an effective way to handle multiple types of quality values that may need to be considered for the quality measurement.

Therefore, there is a need for an improved method and mechanism to define and measure a quality performance index for multiple types of quality values.

### SUMMARY

Some embodiments of the invention provide a method and mechanism to implement a framework for defining multiple Quality Variables, where each quality variable corresponds to its own “weight” (influence factor), measurement definitions, control range values and normalization formula. The framework allows for calculating a composite Quality Performance Index (QPI) which is flexible enough to handle any number of quality variables.

Further details of aspects, objects, and advantages of the invention are described below in the detailed description, drawings, and claims. Both the foregoing general description and the following detailed description are exemplary and explanatory, and are not intended to be limiting as to the scope of the invention.

### BRIEF DESCRIPTION OF THE DRAWINGS

The drawings illustrate the design and utility of embodiments of the present invention, in which similar elements are referred to by common reference numerals. In order to better appreciate the advantages and objects of embodiments of the invention, reference should be made to the accompanying drawings. However, the drawings depict only certain embodiments of the invention, and should not be taken as limiting the scope of the invention.

FIG. 1 shows an architecture of a system for implementing a quality index according to some embodiments of the invention.

FIG. 2 illustrates a flowchart of an approach for implementing some embodiments of the invention.

FIG. 3 illustrates an example framework for performing quality analysis according to some embodiments of the invention.

FIG. 4 is a flow diagram illustrating a method for calculating QPI using a calculation engine in accordance with some embodiments of the invention.

FIG. 5 is a flow diagram illustrating a method for normalizing QPIs using a normalization engine in accordance with some embodiments of the invention.

FIG. 6 is a flow diagram illustrating a method for generating a composite weighted average QPI using a composite weighted average engine in accordance with some embodiments of the invention.

FIG. 7 is a flow diagram illustrating a method for presenting composite weighted average QPI information and normalized QPI information using a presentation engine in accordance with some embodiments of the invention.

FIG. 8 depicts a computerized system on which an embodiment of the invention can be implemented.

### DETAILED DESCRIPTION

Various embodiments are described hereinafter with reference to the figures. It should be noted that the figures are not drawn to scale and that the elements of similar structures or functions are represented by like reference numerals throughout the figures. It should be noted that the figures are only intended to facilitate the description of the embodiments. They are not intended as an exhaustive description of the invention or as a limitation on the scope of the invention. In addition, an illustrated embodiment need not have all the aspects or advantages shown. An aspect or an advantage described in conjunction with a particular embodiment is not necessarily limited to that embodiment and can be practiced in any other embodiments even if not so illustrated. Also, reference throughout this specification to “some embodiments” or “other embodiments” means that a particular feature, structure, material, or characteristic described in connection with the embodiments is included in at least one embodiment. Thus, the appearances of the phrase “in some embodiment” or “in other embodiments” in various places throughout this specification are not necessarily referring to the same embodiment or embodiments. In addition, for the purposes of illustration and explanation, the present disclosure is described in various embodiments in the context of enterprise resource planning (“ERP”) applications. It is noted, however, that the invention is not limited in its scope to ERP applications, and indeed, may be applied to other types of applications as well.

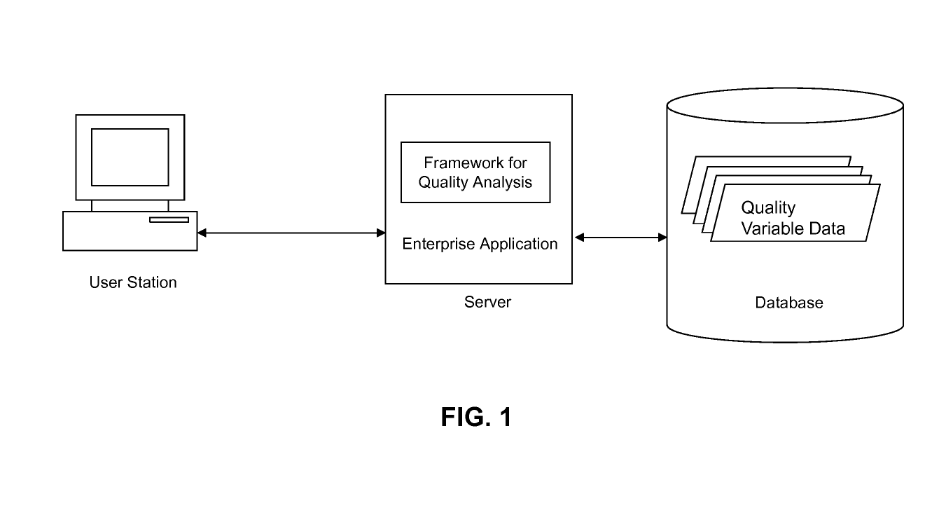

FIG. 1 shows an architecture of a system for implementing a quality performance index according to some embodiments of the invention. The users at the user station operate the system to access and utilize an enterprise application on an application server, such as an ERP interactive application. The user station comprises any type of computing station that may be used to operate or interface with the application server. Examples of such user stations include for example, workstations, personal computers, laptop computers, or remote computing terminals. The user station comprises a display device, such as a display monitor or screen, for displaying interface elements and report data to the user. The user station may also comprise one or more input devices for the user to provide operational control over the activities of the system, such as a mouse, touch screen, keypad, or keyboard. The users of the user station correspond to any individual, organization, or other entity that uses system to access applications on application server, such as the ERP interactive application on the application server.

The database corresponds to any type of computer readable mediums or storage devices. The computer readable storage devices comprise any combination of hardware and software that allows for ready access to the data within database. For example, the computer readable storage device could be implemented as computer memory or disk drives operatively managed by an operating system.

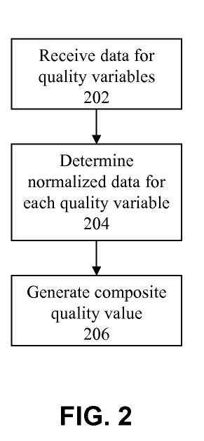

The system includes a framework for defining multiple Quality Variables, where each quality variable corresponds to its own “weight” (influence factor), measurement definitions, control range values and normalization formula. The framework allows for calculating a composite Quality Performance Index (QPI) which is flexible enough to handle any number of quality variables. FIG. 2 shows a flowchart of an approach to implement the quality framework according to some embodiments of the invention. At 202, data is received for the quality variables. The following are examples of quality variables that can be used in embodiments of the invention:
Test Run Percentage=What percentage of the planned tests have been run
Test Pass Percentage=Of the tests that have been run, what percentage have passed successfully
Defect Discovery Rate=What is the increase or decrease in discovering new defects this week compared to last 4 weeks
Critical Defects Percentage=Of all the open defects against this project, what percentage are deemed critical

The measurement of actual values for these variables can be implemented in any suitable way. For example, the test run and test pass percentage can be captured directly from a test reporting system and the defect discovery and critical defects percentage can be captured from a defect reporting system and/or bugs database.

Conventional systems do not provide any defined way to measure planned values for these variables (which is used to calculate the QPI as described in more detail below). Embodiments of the invention provide an effective framework for the project managers to quickly define the planned values. The system receives some or all of the following items of information for each Quality Variable (e.g., provided by a project manager):
1. Tolerance Threshold (Lower Limit): This is the lower limit or starting value of acceptable range for the quality variable. This will be the planned value for the quality variable on the Start date (listed in #3 below).
2. Pass Criteria (Upper Limit): This is the upper limit (equivalent of “completion”) of the acceptable range for the quality variable. This will be the planned value for the quality variable on the End date (listed in #3 below).
3. Date Range (Start and end date for measurements): These are the start and end dates between which the quality variable should be evaluated and reported against.
4. Weight: Relative weight of the quality variable compared to other quality variables; to be used when calculating the composite score.

At 204, normalized data is determined for each quality variable. In some embodiments, for each individual Quality Variable to be included in the Quality Performance Index (QPI) calculation, the measured value is normalized on a scale similar to Schedule and Cost Performance Indices:
If QPI is greater than one, it means the project quality is better than accepted criteria at that point in time for the project.
If QPI is less than one, it means the project quality is worse than accepted criteria at that point in time for the project.
If QPI is equal to one, it means the project quality is equal to the accepted criteria at that point in time for the project.

In some embodiments, the QPI for a quality variable is calculated using the following equation:

Quality Performance Index=(Actual Value Measured)/(Planned Value)

Thereafter, at 206, a composite/overall quality performance index value is obtained. The composite value combines the normalized data for the individual quality variable values, where the combination takes into account any weights that have been established for the quality variables.

As an illustrative example of an embodiment of the invention, consider how the quality performance index can be calculated for the quality variable pertaining Test Run Percentage. The following sets forth an example for the weight, measurement definitions, control range values, and normalization configuration for this quality variable:

| | |
|---|---|
| Name | Test Run Percentage |
| Measure | % of total tests executed |
| Weight | 1 |
| Tolerance Threshold (Lower Limit) (LL) | 0% |
| Pass criteria (Upper Limit) (UL) | 100% |
| Start Date (SD) | Jan. 01, 2013 |
| End Date (ED) | Jun. 30, 2013 |

The following shows an example of pseudocode utilized to implement a formula that can be used to calculate the planned value for the Test Run Percentage on any given day:

Current Date = CD
Start Date = SD
UL = Pass Criteria/Upper Limit
LL = Threshold/Lower Limit
IF CD < SD THEN

Planned Test Run Percentage = N/A

ELSE

Planned Test Run Percentage = Minimum Of

a. [(CD−SD)/(ED−SD]*[(UL−LL)+LL]
b. UL

The following chart illustrates examples of planned values based on the data listed in above table:

| | Planned Value on the Date |
|---|---|
| Calculation Date | (based on above formula) |
| Jan. 1, 2013 | 0% |
| Feb. 1, 2013 | 17% |
| Mar. 1, 2013 | 33% |
| Apr. 1, 2013 | 50% |
| May 1, 2013 | 67% |
| Jun. 1, 2013 | 84% |
| Jun. 30, 2103 | 100% |
| Jul, 15, 2013 | 100% |

As noted above, the Quality Performance Index for Test Run Percentage on any given date can be calculated as:

Quality Performance Index=Actual Value Measured/Planned Value

The QPI can similarly be calculated for each of the plurality of Quality Variables. The overall QPI (composite Quality Performance Index) is calculated using the weighted average formula.

For example, assume that there are four Quality Variables are denoted by Q1, Q2, Q3, Q4. The respective individual QPIs calculated using the model above are QPI1, QPI2, QPI3, QPI4. The respective weights for the four quality variables are W1, W2, W3, W4. The following pseudocode utilized to implement the formula can be used to calculate the overall/composite Quality Performance Index:

[(QPI1*W1)+(QPI2*W2)+(QPI3*W3)+(QPI4*W4)]

Where W1+W2+W3+W4=1

With this formula, there is a potential that one Quality Variable might have an overbearing effect on the calculation of the overall QPI. In spite of the weights, there can be cases where the QPI for one quality variable can be so high that it might mask the concerns on one or more other quality variables. Hence, a modified version of the pseudocode used to implement the formula above was used for implementation in some embodiments:

MAX QPI = 1.05
{ [MINIMUM OF (QPI1, MAX QPI)*W1]+[MINIMUM OF (QPI2,
MAX QPI)*W2]+[MINIMUM OF (QPI3, MAX QPI)*W3]+[MINIMUM
OF (QPI4, MAX QPI)*W4] }
WHERE W1+W2+W3+W4 = 1

The formula listed above is an example for an implementation where a set of four quality variables was used. However, as listed previously, the framework is flexible enough to be extended to any number of quality variables.

The following is an example of pseudocode used to implement a generic formula for n quality variables:

MAX QPI = X
Composite QPI = SUM OF
{

[MINIMUM OF (QPI1, MAX QPI) *W1],
[MINIMUM OF (QPI2, MAX QPI) *W2],
[MINIMUM OF (QPI3, MAX QPI) *W3],
[MINIMUM OF (QPI4, MAX QPI) *W4],
. . .
. . .
. . .
[MINIMUM OF (QPIn, MAX QPI) *Wn],

}
WHERE W1+W2+W3+W4+.... +Wn = 1

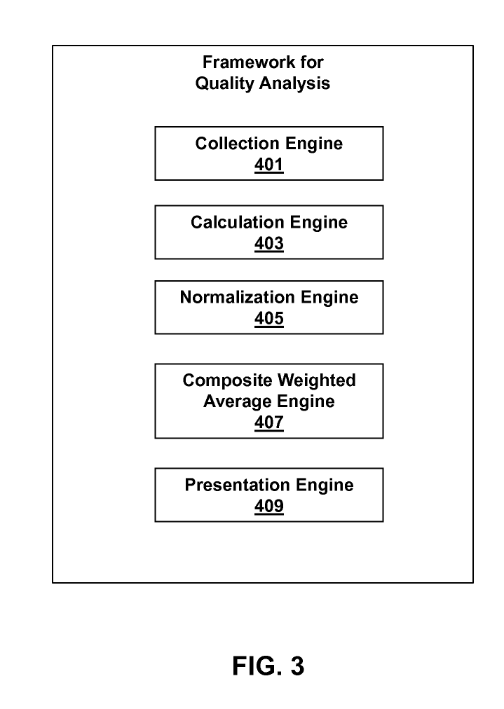

FIG. 3 illustrates an example framework for performing quality analysis according to some embodiments of the invention. The framework may include several different modules/engines for implementing quality analysis. In FIG. 3, the framework includes a collection engine 401, a calculation engine 403, a normalization engine 405, a composite weighted average engine 407 and a presentation engine 409.

The collection engine 401 is configured to collect information needed to perform quality analysis. The collection engine may be configured to retrieve threshold/lower limit values for a quality variable, upper limit/pass criteria for a quality variable, date ranges for a quality variable, actual measured values for a quality variable, normalization rules for a quality variable, and weight distribution rules for calculating composite weighted average quality performance index (QPI) values, which will be described in greater detail below.

Additionally, the collection engine 401 may be configured to schedule the different tasks needed to generate a composite quality performance index value including scheduling when QPI calculations for quality variables are to be performed, when normalization of QPI of quality variables are to be performed, when composite weighted average QPI values are to be calculated, and when composite weighted average QPI values are to be presented. The collection engine 401 may schedule such tasks based on an prioritization scheme defined by a user, or may schedule such tasks in a load-balanced manner to efficiently utilize resources for generating a composite quality performance index value.

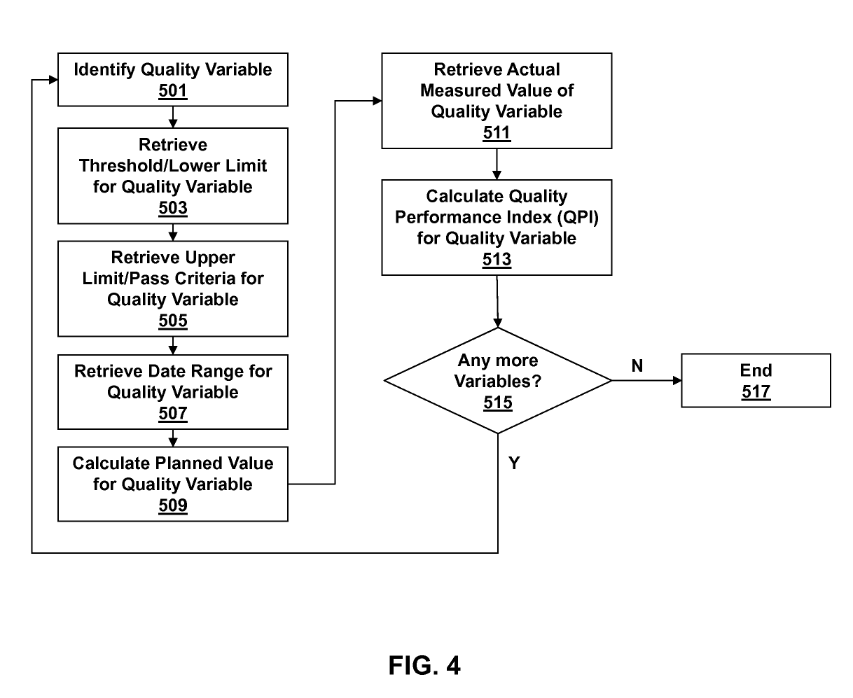

The calculation engine 403 may be configured to identify quality variables and to calculate a quality performance index (QPI) for a quality variable using information collected by the collection engine. FIG. 4 is a flow diagram illustrating a method for calculating QPI using a calculation engine in accordance with some embodiments of the invention.

Initially, the calculation engine identifies a quality variable for which a QPI is to be calculated as shown at 501. The quality variable will be associated with a number of parameters that are used for calculating a QPI. For example, a quality variable may be associated with a threshold/lower limit, a pass criteria/upper limit, and a date range.

The calculation engine first retrieves the threshold/lower limit for the quality variable as shown at 503. For example, the quality variable may pertain to a test run percentage, where the threshold/lower limit for the test run percentage is 0%, which indicates that a minimum number of tests that are run are 0%.

The calculation engine may then retrieve the pass criteria/upper limit for the quality variable as shown at 505. For example, where the quality variable pertains to a test run percentage, the pass criteria/upper limit may be 100%, which indicates that 100% of tests must be run to meet the pass criteria.

Next, the calculation engine may retrieve a date range for the quality variable as shown at 507. The date range indicates the start date and end date for a particular project having that quality variable. For example, the date range may indicate that the project is to start on Jan. 1, 2013 and end on Jun. 30, 2013.

The calculation engine then utilizes these parameters to calculate a planned value for a quality variable as shown at 509. The planned valued provides an indication of the projected value of a quality variable at a given date. For example, the planned value may indicate that on Feb. 21, 2013, the projected percentage of tests that are to have been run is 17%.

The planned value may be calculated using any number of different formulas. One example of pseudocode utilized to implement a formula that may be used for calculating the planned value for a quality variable can be found below:

Current Date = CD
Start Date = SD
UL = Pass Criteria/Upper Limit
LL = Threshold/Lower Limit
IF CD < SD THEN

Planned Test Run Percentage = N/A

ELSE

Planned Test Run Percentage = Minimum Of
a. [(CD−SD)/(ED−SD]*[(UL−LL)+LL]
b. UL

By using the formula above, the planed value for the percentage of tests run quality variable will be 17% as of Feb. 1, 2013. The planned value will then be compared to the actual measure value for the quality variable for calculating a QPI for the quality variable, which will be discussed in additional detail below.

Once the planned value for the quality variable is calculated, then the actual measured value for the quality variable is retrieved as shown at 511. The actual measured value for the quality variable represents the measured value of the quality variable at a given date, rather than the projected value of the quality variable at the given date.

The QPI for the quality variable may then be calculated using the planned value for the quality variable and the actual measured value of the quality variable as shown at 513. For example, the QPI may be calculated by dividing the actual measured value for the quality variable on a given date by the planned value for the quality variable on the given date. Where the actual measured value of the projected percentage of tests run quality variable is 34% as of Feb. 1, 2013 and the panned value of the projected percentage of tests run quality variable is 17%, then the QPI for that quality variable will be 2.

The calculation engine then determines whether any additional quality variables remain as indicated at 515. If there are quality variable remaining to be calculated, then the calculation engine returns to 501 where it identifies another quality variable to be calculated. If there are no additional quality variables to be calculated, then the calculation engine has completed its calculations for a given project and ends as shown at 517. After calculating QPIs for any number of quality variables, the calculation engine may store those values for additional processing.

A normalization engine 405 may also be implemented within the framework for quality analysis to normalize QPIs for quality variables. Normalization involves adjusting a QPI for a quality variable to fit a common scale, such that different QPIs for different quality variables may be compared against each other.

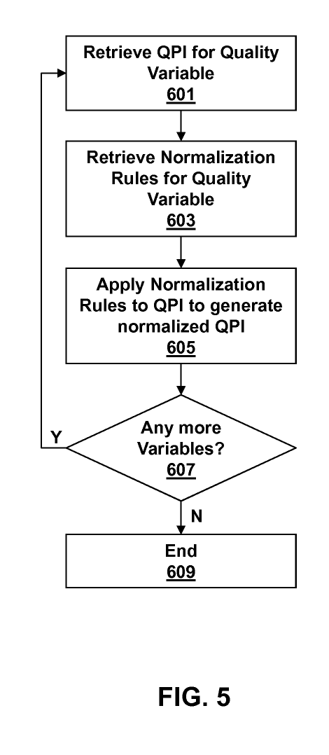

FIG. 5 is a flow diagram illustrating a method for normalizing QPIs using a normalization engine in accordance with some embodiments of the invention. Initially, the normalization engine retrieves a QPI for a quality variable as shown at 601. The QPI for the quality variable was previously calculated and stored by the calculation engine and may subsequently be retrieved by the normalization engine.

The normalization engine then retrieves normalization rules for the quality variable as shown at 603. Each quality variable may be associated with a set of normalization rules for normalizing the QPI associated with the quality variable such that multiple QPIs for different quality variables may be compared using a common scale. Depending on the quality variable being normalized, a different set of normalization rules may be applicable.

Once the normalization engine retrieves the normalization rules for the quality variable, it applies the normalization rules to the QPI for that quality variable to generate a normalized QPI for that quality variable as shown at 605. The normalization engine then makes a determination as to whether any other quality variables are to be normalized as shown at 607. If there are additional quality variables to be normalized, then the normalization engine returns to 601 where it retrieves the QPI for another quality variable. If there are no additional quality variables to be normalized, then the normalization engine stores those values for additional processing.

A composite weighted average engine 407 may also be implemented within the framework for quality analysis to generate a composite weighted average QPI for any number of quality variables relevant to the project under evaluation. Generating a composited weighted average QPI involves assigning weights to different quality variables based on their importance to the project under evaluation.

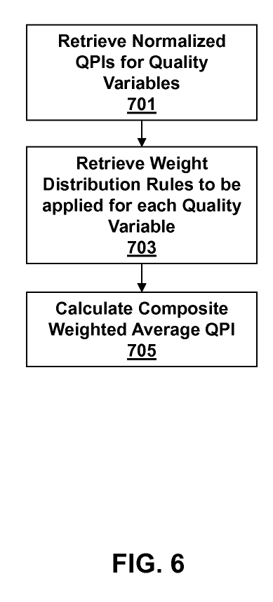

FIG. 6 is a flow diagram illustrating a method for generating a composite weighted average QPI using a composite weighted average engine in accordance with some embodiments of the invention.

Initially, the normalized QPIs for the quality variables under evaluation are retrieved as shown at 701. The normalized QPIs for the different quality variables were previously calculated and stored by the normalization engine and may be subsequently retrieved by the composite weighted average engine.

The weight distribution rules to be applied to each quality variable may then be retrieved as shown at 703. For example, assume that four quality variables Q1, Q2, Q3 and Q4 are under evaluation and that normalized QPIs of QPI1, QPI2, QPI3 and QPI4 have been calculated for each quality variable. The weight distribution rules may simply indicate that weights W1, W2, W3 and W4 are to be assigned to the respective QPIs and that the composite weighted average QPI is calculated using the following formula: [(QPI1*W1)+(QPI2*W2)+(QPI3*W3)+(QPI4*W4)].

Alternatively, the weight distribution rules may indicate that a modified formula is to be used to limit the potential that one quality variable may have an overbearing effect on the calculation of the overall QPI. Pseudocode for implementing such a formula may look like:

MAX QPI = 1.05
{[MIN OF (QPI1, MAX QPI) * W1] + [MIN OF (QPI2, MAX
QPI) * W2] + [MIN OF (QPI3, MAX QPI) * W3] + [MIN OF
(QPI4, MAX QPI) * W4]}
WHERE W1 + W2 + W3 + W4 = 1

Once the weight distribution rules have been retrieved, then the composite weighted average QPI may be calculated by applying the weight distribution rules to the normalized QPIs for the different quality variables under evaluation as shown at 705. The composite weight average engine may then store those values for additional processing.

Lastly, a presentation engine 409 may be implemented within the framework for quality analysis to present composite weighted average QPI information as well as normalized QPI information for a user. Both a current composite weighted average QPI and historical composite weighted average QPIs may be presented to the user. Similarly, both current normalized QPI information and historical normalized QPI information may be presented to the user.

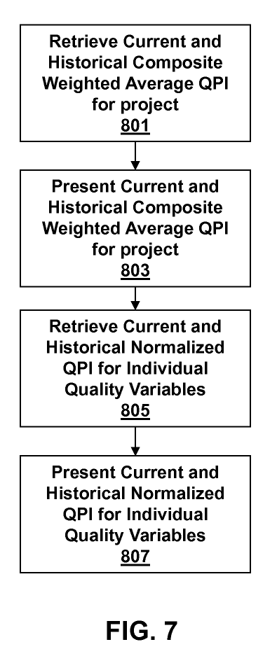

FIG. 7 is a flow diagram illustrating a method for presenting composite weighted average QPI information and normalized QPI information using a presentation engine in accordance with some embodiments of the invention. Initially, the presentation engine may retrieve current and historical composite weighted average QPIs for a given project as shown at 801. The presentation engine may retrieve composited weighted average QPIs previously calculated and stored by the composite weighted average engine. The presentation engine may retrieve any number of historical composite weighted average QPIs depending on the amount of information the user is looking for.

The presentation engine may then present current and historical composite weighted average QPIs for the project as shown at 803. The presentation engine may present any number of historical composite weighted average QPIs depending on the type of information that the user is looking for.

Next, the presentation engine may retrieve current and historical normalized QPIs for individual quality variables for the given project as shown at 805. The presentation engine may retrieve any number of historical QPIs for individual quality variables depending on the amount of information the user is looking for

The presentation engine may then present current and historical normalized QPIs for individual quality variables for the given project as shown at 807. The presentation engine may present any number of historical composite weighted average QPIs depending on the type of information that the user is looking for.

Therefore, what has been described is an approach that efficiently provides a framework for defining multiple Quality Variables, where each quality variable corresponds to its own “weight” (influence factor), measurement definitions, control range values and normalization formula. The framework allows for calculating a composite Quality Performance Index (QPI) which is flexible enough to handle any number of quality variables.

The present approach provides a composite weighted formula for the QPI that can take into account multiple quality variables (QVs) that need to be measured in order to evaluate the quality on a project. The approach can account for the fact that these different variables have varying influence (weight) on the overall quality over the duration of the project.

In addition, the invention can handle multiple dimensions of measurements, where different quality variables (QVs) correspond to different scales of measurement (e.g. some variables will be measured as % complete, others will be measured as absolute numbers, each variable will have different acceptable ranges of measurements for the project, etc.). These different dimensions of measurements can be normalized in order to calculate a single composite value.

### System Architecture Overview

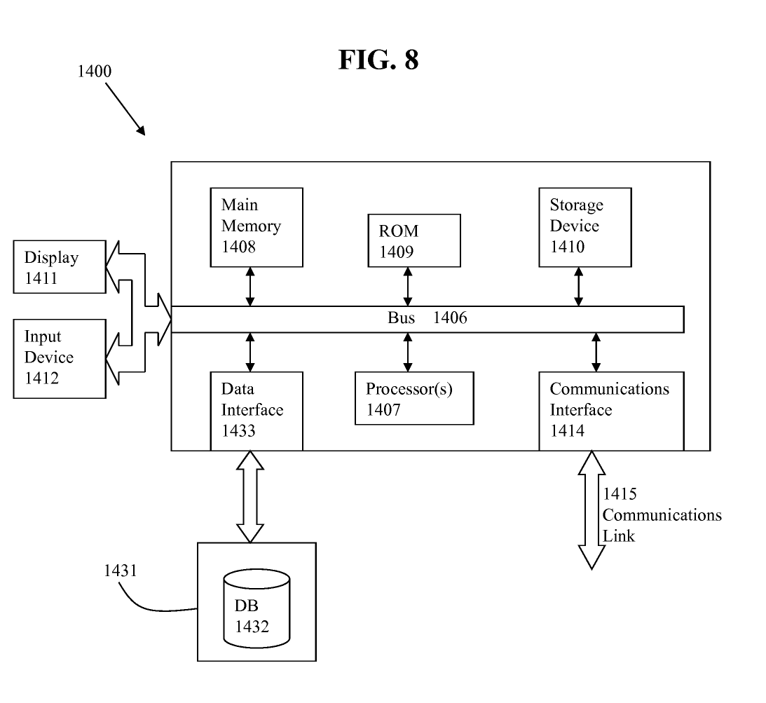

FIG. 8 is a block diagram of an illustrative computing system 1400 suitable for implementing an embodiment of the present invention. Computer system 1400 includes a bus 1406 or other communication mechanism for communicating information, which interconnects subsystems and devices, such as processor 1407, system memory 1408 (e.g., RAM), static storage device 1409 (e.g., ROM), disk drive 1410 (e.g., magnetic or optical), communication interface 1414 (e.g., modem or Ethernet card), display 1411 (e.g., CRT or LCD), input device 1412 (e.g., keyboard), and cursor control.

According to one embodiment of the invention, computer system 1400 performs specific operations by processor 1407 executing one or more sequences of one or more instructions contained in system memory 1408. Such instructions may be read into system memory 1408 from another computer readable/usable medium, such as static storage device 1409 or disk drive 1410. In alternative embodiments, hard-wired circuitry may be used in place of or in combination with software instructions to implement the invention. Thus, embodiments of the invention are not limited to any specific combination of hardware circuitry and/or software. In one embodiment, the term “logic” shall mean any combination of software or hardware that is used to implement all or part of the invention.

The term “computer readable medium” or “computer usable medium” as used herein refers to any medium that participates in providing instructions to processor 1407 for execution. Such a medium may take many forms, including but not limited to, non-volatile media and volatile media. Non-volatile media includes, for example, optical or magnetic disks, such as disk drive 1410. Volatile media includes dynamic memory, such as system memory 1408.

Common forms of computer readable media includes, for example, floppy disk, flexible disk, hard disk, magnetic tape, any other magnetic medium, CD-ROM, any other optical medium, punch cards, paper tape, any other physical medium with patterns of holes, RAM, PROM, EPROM, FLASH-EPROM, any other memory chip or cartridge, or any other medium from which a computer can read.

In an embodiment of the invention, execution of the sequences of instructions to practice the invention is performed by a single computer system 1400. According to other embodiments of the invention, two or more computer systems 1400 coupled by communication link 1415 (e.g., LAN, PTSN, or wireless network) may perform the sequence of instructions required to practice the invention in coordination with one another.

Computer system 1400 may transmit and receive messages, data, and instructions, including program, i.e., application code, through communication link 1415 and communication interface 1414. Received program code may be executed by processor 1407 as it is received, and/or stored in disk drive 1410, or other non-volatile storage for later execution.

In the foregoing specification, the invention has been described with reference to specific embodiments thereof. It will, however, be evident that various modifications and changes may be made thereto without departing from the broader spirit and scope of the invention. For example, the above-described process flows are described with reference to a particular ordering of process actions. However, the ordering of many of the described process actions may be changed without affecting the scope or operation of the invention. The specification and drawings are, accordingly, to be regarded in an illustrative rather than restrictive sense.

What is claimed is:

1. A computer implemented method, comprising:
identifying a plurality of quality variables to be evaluated;
retrieving thresholds/lower limits for the plurality of quality variables;
retrieving upper limits/pass criteria for the plurality of quality variables;
retrieving date ranges for the plurality of quality variables;
calculating planned values for the plurality of quality variables at a given date;
retrieving actual measured values for the plurality of quality variables at the given date;
calculating quality performance indices for the plurality of quality variables based at least in part upon the actual measured values and the planned values; and
calculating a composite quality performance index by aggregating the quality performance indices for the plurality of quality variables.

2. The method of claim 1, further comprising normalizing the quality performance indices for the plurality of quality variables.

3. The method of claim 2, wherein normalizing a quality performance index for a quality variable comprises applying normalization rules for the quality variable against the quality performance index for the quality variable.

4. The method of claim 1, wherein calculating the composite quality performance index comprises:
retrieving weight distribution rules for the plurality of quality variables; and
applying the weight distribution rules to the quality performance indices of the plurality of quality variables.

5. The method of claim 1, further comprising presenting the composite quality performance index to a user.

6. The method of claim 5, further comprising presenting a historical composite quality performance index to the user.

7. The method of claim 6, wherein the historical composite quality performance index is for a date prior to the given date.

8. A computer implemented method implemented with a processor, comprising:
receiving data for a plurality of quality variables;
normalizing the data for the quality variables to generate normalized data; and
obtaining a composite quality value using the normalized data.

9. The method of claim 8, wherein the data for the quality variable comprises weight, a measurement definition, a control range, and/or a normalization formula.

10. The method of claim 8, in which the data for the quality variable comprises: test run percentage, test pass percentage, defect discovery rate, or critical defects percentage.

11. The method of claim 8, in which the data for the quality variable is captured from a test reporting system, a defect reporting system, and/or a bug database.

12. The method of claim 8, in which the data for the quality variable comprises: tolerance threshold, pass criteria, date range, or weight.

13. The method of claim 12, in which the tolerance threshold comprises a lower limit or a starting value of acceptable range for a quality variable.

14. The method of claim 12, in which the pass criteria comprises an upper limit of an acceptable range for the quality variable.

15. The method of claim 12, in which the date range comprises a start and end date for measurements of the quality variable.

16. The method of claim 12, in which the weight comprises a relative weighting of the quality variable compared to other quality variables.

17. The method of claim 8, in which the normalized data comprises a Quality Performance Index value calculated for the quality variable.

18. The method of claim 17, in which the quality performance index (QPI) comprises the following parameters:
project quality is better than accepted criteria at a point in time for a project if the QPI is greater than one;
project quality is worse than accepted criteria at the point in time for the project if the QPI is less than one; and
project quality is equal to the accepted criteria at the point in time for the project if the QPI is equal to one.

19. The method of claim 17, in which the quality performance index corresponds to an actual value measured for the quality variable divided by a planned value for the quality variable.

20. The method of claim 8, in which the composite quality value combines the normalized data for the individual quality variable values.

21. The method of claim 20, in which the composite quality value combines the normalized data for the individual quality variable values by taking into account a weighting for the quality variables.

22. The method of claim 8, in which the composite quality value is obtained by limiting the data for one quality variable from over-influencing the composite quality value with respect to other quality variables.

23. The method of claim 22, in which the composite quality value is obtained by aggregating a quality performance index for each quality variable, wherein the quality performance index for each quality variable is a minimum of the normalized data for the quality variable and a maximum quality performance index value.

24. A computer readable medium having stored thereon a sequence of instructions which, when executed by a processor causes the processor to execute a method comprising:
receiving data for a plurality of quality variables;
normalizing the data for the quality variables to generate normalized data; and
obtaining a composite quality value using the normalized data.

25. The computer readable medium of claim 24, wherein the data for the quality variable comprises weight, a measurement definition, a control range, and/or a normalization formula.

26. The computer readable medium of claim 24, in which the data for the quality variable comprises some or all of the following: Test Run Percentage, Test Pass Percentage, Defect Discovery Rate, Critical Defects Percentage.

27. The computer readable medium of claim 24, in which the data for the quality variable is captured from a test reporting system, a defect reporting system, and/or a bug database.

28. The computer readable medium of claim 24, in which the data for the quality variable comprises some or all of the following: Tolerance Threshold, Pass Criteria, Date Range, Weight.

29. The computer readable medium of claim 28, in which the tolerance threshold comprises a lower limit or a starting value of acceptable range for a quality variable.

30. The computer readable medium of claim 28, in which the pass criteria comprises an upper limit of an acceptable range for the quality variable.

31. The computer readable medium of claim 28, in which the date range comprises a start and end date for measurements of the quality variable.

32. The computer readable medium of claim 28, in which the weight comprises a relative weighting of the quality variable compared to other quality variables.

33. The computer readable medium of claim 28, in which the normalized data comprises a Quality Performance Index value calculated for the quality variable.

34. The computer readable medium of claim 33, in which the quality performance index comprises the following parameters:
project quality is better than accepted criteria at a point in time for a project, if the QPI is greater than one;
project quality is worse than accepted criteria at the point in time for the project, if the QPI is less than one;
project quality is equal to the accepted criteria at the point in time for the project, if the QPI is equal to one.

35. The computer readable medium of claim 33, in which the quality performance index corresponds to an actual value measured for the quality variable divided by a planned value for the quality variable.

36. The computer readable medium of claim 24, in which the composite quality value combines the normalized data for the individual quality variable values.

37. The computer readable medium of claim 36, in which the composite quality value combines the normalized data for the individual quality variable values by taking into account a weighting for the quality variables.

38. The computer readable medium of claim 24, in which the composite quality value is obtained by limiting the data for one quality variable from over-influencing the composite quality value with respect to other quality variables.

39. The computer readable medium of claim 38, in which the composite quality value is obtained by aggregating a quality performance index for each quality variable, wherein the quality performance index for each quality variable is a minimum of the normalized data for the quality variable and a maximum quality performance index value.

40. A system, comprising:
a processor;
a memory comprising computer code executed using the processor, in which the computer code implements receiving data for a plurality of quality variables, normalizing the data for the quality variables to generate normalized data, and obtaining a composite quality value using the normalized data.

41. The system of claim 40, wherein the data for the quality variable comprises weight, a measurement definition, a control range, and/or a normalization formula.

42. The system of claim 40, in which the data for the quality variable comprises some or all of the following: Test Run Percentage, Test Pass Percentage, Defect Discovery Rate, Critical Defects Percentage.

43. The system of claim 40, in which the data for the quality variable is captured from a test reporting system, a defect reporting system, and/or a bug database.

44. The system of claim 40, in which the data for the quality variable comprises some or all of the following: Tolerance Threshold, Pass Criteria, Date Range, Weight.

45. The system of claim 44, in which the tolerance comprises a lower limit or a starting value of acceptable range for a quality variable.

46. The system of claim 44, in which the pass criteria comprises an upper limit of an acceptable range for the quality variable.

47. The system of claim 44, in which the date range comprises a start and end date for measurements of the quality variable.

48. The system of claim 44, in which the weight comprises a relative weighting of the quality variable compared to other quality variables.

49. The system of claim 40, in which the normalized data comprises a Quality Performance Index value calculated for the quality variable.

50. The system of claim 49, in which the quality performance index (QPI) comprises the following parameters:
project quality is better than accepted criteria at a point in time for a project, if the QPI is greater than 1;
project quality is worse than accepted criteria at the point in time for the project, if the QPI is less than 1;
project quality is equal to the accepted criteria at the point in time for the project, if the QPI is equal to 1.

51. The system of claim 49, in which the quality performance index corresponds to an actual value measured for the quality variable divided by a planned value for the quality variable.

52. The system of claim 40, in which the composite quality value combines the normalized data for the individual quality variable values.

53. The system of claim 52, in which the composite quality value combines the normalized data for the individual quality variable values by taking into account a weighting for the quality variables.

54. The system of claim 40, in which the composite quality value is obtained by limiting the data for one quality variable from over-influencing the composite quality value with respect to other quality variables.

55. The system of claim 54, in which the composite quality value is obtained by aggregating a quality performance index for each quality variable, wherein the quality performance index for each quality variable is a minimum of the normalized data for the quality variable and a maximum quality performance index value.

56. The system of claim 40, further comprising a collection engine for collecting data for the plurality of quality variables for performing quality analysis.

57. The system of claim 40, further comprising a calculation engine for calculating quality performance indices for the plurality of quality variables.

58. The system of claim 40, further comprising a normalization engine for normalizing the data for the quality variables to generate normalized data.

59. The system of claim 40, further comprising a composite average engine for generating the composite quality value using the normalized data.

60. The system of claim 40, further comprising a presentation engine for presenting the composite quality value.
